(19) United States
(12) Patent Application Publication
(10) Pub. No.: US 2003/0126012 A1
(43) Pub. Date: Jul. 3, 2003

(54) Method and apparatus for motivating a customer to save money for use with later purchases

(76) Inventors: Irvin B. Watts, New Milford, CT (US); Thomas Arcuri, New Milford, CT (US); Neil Bryson, Norwalk, CT (US)

Correspondence Address: BUCKLEY, MASCHOFF, TALWALKAR, & ALLISON, 5 ELM STREET, NEW CANAAN, CT, 06840, US

(21) Appl. No.: 10/036,170

(22) Filed: Dec. 31, 2001

(51) Int. Cl. G06F 17/60

(52) U.S. Cl. 705/14

(57) ABSTRACT

A system, method, apparatus, means, and computer program code for providing a benefit to a customer who saves money for use with one or more later purchases. According to embodiments of the present invention, a customer is provided with an account upon an establishment date and the customer may add or add to a benefit (e.g., monetary amount) associated with the account. The customer may be limited or even prevented from accessing any monetary amount or other benefit associated with the account until a later date referred to herein as the activation date. A merchant or other party may add a bonus or additional benefit to the account upon the activation date or on another date. The amount of the bonus or additional benefit may depend on how much the customer has increased the account after the establishment date.

### FIELD OF THE INVENTION

The present invention relates to a method and apparatus for motivating a customer to save money for use when making later purchases and, more particularly, embodiments of the present invention relate to methods, means, apparatus, and computer program code for providing a benefit to a customer who establishes an account to save money for use when making later purchases.

### BACKGROUND OF THE INVENTION

Many merchants provide or allow layaway plans as a way of allowing customers to purchase products. In a typical layaway plan, customer pays to a merchant some portion of a product's price and the rest is paid by the customer over time. The product is stored by the merchant until the customer has paid the full price. Such layaway plans are particularly attractive to customers during the holiday season as they guarantee the customers the rights to possess certain products after the prices for the products are paid. In essence, layaway plans become savings plans for customers wanting to purchase specific products.

Unfortunately, merchants offering such layaway plans may have significantly increased employee and storage costs since products put on layaway must be stored and not sold to other customers. In addition, additional employees may be needed to store and retrieve products as well as to work with customers placing products on layaway, making payments, retrieving products, etc.

It would be advantageous to provide a system, method, apparatus, means, and computer program code that motivated customers to save for later purchases while limiting the need of a merchant to store products offered via a layaway option to customers. In addition, it would be advantageous to provide a system, method, apparatus, means, and computer program code that increased a customer's ability to make full payment for a product such that the customer did not have to place the product on layaway.

### SUMMARY OF THE INVENTION

Embodiments of the present invention provide a system, method, apparatus, means, and computer program code for providing a benefit to a customer who uses an account to save money for use when making later purchases. According to embodiments of the present invention, an account is established for a customer that allows the customer to add to or increase a benefit associated with the account. The benefit may not be usable or accessible by the customer until a later date, thereby allowing the customer to build up a benefit in advance over time. The benefit may include a monetary amount. When established, an account may have a zero balance associated with it. However, once the account is established, the customer may deposit money to the account or otherwise build up the account over time. Upon an activation date associated with the account, the customer can access or otherwise use the monetary amount or other benefit associated with the account. In addition, a merchant or other party may add to the monetary amount or other benefit associated with the account. The amount of the increase by the merchant may depend, at least in party, on the amount of the increase provided by the customer. The customer may be informed of the availability or possibility of the increased amount when the account is first established so that the customer is motivated to increase the monetary amount prior to the activation date.

Additional objects, advantages, and novel features of the invention shall be set forth in part in the description that follows, and in part will become apparent to those skilled in the art upon examination of the following or may be learned by the practice of the invention.

According to embodiments of the present invention, a method for providing a benefit to a customer may include establishing an account for a customer; allowing the customer to increase a first benefit associated with the account, wherein the customer cannot use the first benefit until an activation date associated with the account; associating a second benefit with the account at the activation date; and allowing the customer to use the first benefit and the second benefit after the activation date. In another embodiment, a method for providing a benefit to a customer may include establishing an account for a customer on a first date, wherein the account has an associated monetary amount and the customer cannot decrease the monetary amount until a second date; allowing the customer to increase the monetary amount after the first date; increasing the monetary amount at the second date; and allowing the customer to decrease the monetary amount associated with the account after the second date. In a further embodiment, a method for providing a benefit to a customer may include establishing an account for a customer on a first date, wherein the account has an associated monetary amount and the customer cannot decrease the monetary amount until an activation date; providing a notification to the customer indicative of availability of an increase to the monetary amount benefit at the second date an a criterion associated with the increase to the monetary amount; allowing the customer to increase the monetary amount after the first date and before the second date; increasing the monetary amount at the second date if the customer satisfies the criterion; and allowing the customer to decrease the monetary amount after the activation date.

According to embodiments of the present invention, a system for providing a benefit to a customer may include a memory, a communication port, and a processor connected to the memory and the communication port, the processor being operative to establish an account for a customer; allow the customer to increase a first benefit associated with the account, wherein the customer cannot use the first benefit until an activation date associated with the account; associate a second benefit with the account at the activation date; and allow the customer to use the first benefit and the second benefit after the activation date. In another embodiment, a system for providing a benefit to a customer may include a memory, a communication port, and a processor connected to the memory and the communication port, the processor being operative to establish an account for a customer on a first date, wherein the account has an associated monetary amount and the customer cannot decrease the monetary amount until a second date; allow the customer to increase the monetary amount after the first date; increase the monetary amount at the second date; and allow the customer to decrease the monetary amount associated with the account after the second date. In a further embodiment, a system for providing a benefit to a customer may include a memory, a communication port, and a processor connected to the memory and the communication port, the processor being operative to establish an account for a customer on a first date, wherein the account has an associated monetary amount and the customer cannot decrease the monetary amount until an activation date; provide a notification to the customer indicative of availability of an increase to the monetary amount benefit at the second date an a criterion associated with the increase to the monetary amount; allow the customer to increase the monetary amount after the first date and before the second date; increase the monetary amount at the second date if the customer satisfies the criterion; and allow the customer to decrease the monetary amount after the activation date.

According to embodiments of the present invention, a computer program product in a computer readable medium for providing a benefit to a customer may include first instructions for creating an account for a customer; second instructions for facilitating an increase in a first benefit, wherein the customer cannot use the first benefit until an activation date associated with the account; third instructions for adding a second benefit with the account at the activation date; and fourth instructions for facilitating use of the first benefit and the second benefit by the customer. In another embodiment, a computer program product in a computer readable medium for providing a benefit to a customer may include first instructions for creating an account for a customer on a first date, wherein the account has an associated monetary amount and the customer cannot decrease the monetary amount until a second date; second instructions for facilitating an increase by the customer in the monetary amount after the first date; third instructions for creating an increase in the monetary amount at the second date; and fourth instructions for facilitating a decrease by the customer in the monetary amount associated with the account after the second date. In a further embodiment, a computer program product in a computer readable medium for providing a benefit to a customer may include first instructions for creating an account for a customer on a first date, wherein the account has an associated monetary amount and the customer cannot decrease the monetary amount until an activation date; second instructions for providing a notification to the customer indicative of availability of an increase to the monetary amount benefit at the second date an a criterion associated with the increase to the monetary amount; third instructions for allowing facilitating an increase by the customer in the monetary amount after the first date and before the second date; fourth instructions for adding to the monetary amount at the second date if the customer satisfies the criterion; and fifth instructions for facilitating a decrease in the monetary amount by the customer after the activation date.

According to embodiments of the present invention, an apparatus for providing a benefit to a customer may include means for creating an account for a customer; means for facilitating an increase in a first benefit, wherein the customer cannot use the first benefit until an activation date associated with the account; means for adding a second benefit with the account at the activation date; and means for facilitating use of the first benefit and the second benefit by the customer. In another embodiment, an apparatus for providing a benefit to a customer may include means for creating an account for a customer on a first date, wherein the account has an associated monetary amount and the customer cannot decrease the monetary amount until a second date; means for facilitating an increase by the customer in the monetary amount after the first date; means for creating an increase in the monetary amount at the second date; and means for facilitating a decrease by the customer in the monetary amount associated with the account after the second date. In a further embodiment, an apparatus for providing a benefit to a customer may include means for creating an account for a customer on a first date, wherein the account has an associated monetary amount and the customer cannot decrease the monetary amount until an activation date; means for providing a notification to the customer indicative of availability of an increase to the monetary amount benefit at the second date an a criterion associated with the increase to the monetary amount; means for allowing facilitating an increase by the customer in the monetary amount after the first date and before the second date; means for adding to the monetary amount at the second date if the customer satisfies the criterion; and means for facilitating decrease in the monetary amount by the customer after the activation date.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a flowchart of a first embodiment of a method in accordance with the present invention;

FIG. 2 is a flowchart of a second embodiment of a method in accordance with the present invention;

FIG. 3 is a flowchart of a third embodiment of a method in accordance with the present invention;

FIG. 4 is a block diagram of system components for an embodiment of an apparatus usable with the methods of FIGS. 1-3;

FIG. 5 is a block diagram of components for an embodiment of a merchant device of FIG. 4;

FIG. 6 is an illustration of a representative account information database of FIG. 6; and

FIG. 7 is an illustration of a representative customer information database of FIG. 6.

### DETAILED DESCRIPTION

Applicants have recognized that there is a need for systems, means, computer code and methods for motivating and allowing a customer to save in advance for later purchases. Such systems, means and methods may be implemented by, for or on behalf of one or more merchants. A customer is provided with an account upon an establishment date and the customer may add or add to a benefit (e.g., monetary amount) associated with the account. The customer may be limited or even prevented from accessing any monetary amount or other benefit associated with the account until a later date referred to herein as the activation date. A merchant or other party may add a bonus or additional benefit to the account upon the activation date or on another date. The amount of the bonus or additional benefit may depend on how much the customer has increased the account after the establishment date. Each account may have an associated card that is provided to the customer to use when adding amounts to the account, using amounts associated with the account, etc. The card may be branded with a particular merchant to increase the marketing value for the particular merchant. In some embodiments, a merchant may operate or host a World Wide Web site on which customers can check balances associated with accounts, activation and/or termination dates associated with accounts, available bonus for accounts, etc. A technical effect produced by some embodiments of the present invention is that customers may automatically receive bonuses or other benefits automatically as part of their savings process and merchants may automate a rewards process for customers.

A merchant may be or include any store, retailer, restaurant, supplier, manufacturer, shopping center, mall, etc. or a group of one or more of these parties. In some embodiments, information regarding one or more accounts may be stored or found in an account information database. Similarly, information regarding one or more customers may be stored or found in a customer information database and information regarding one or more merchants may be stored in a merchant information database.

Process Description

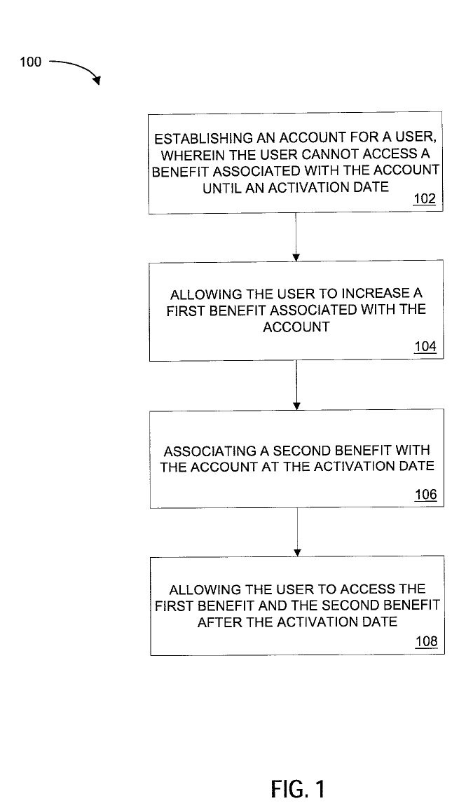

Reference is now made to FIG. 1, where a flow chart 100 is shown which represents the operation of a first embodiment of the present invention. The particular arrangement of elements in the flow chart 100 is not meant to imply a fixed order to the steps; embodiments of the present invention can be practiced in any order that is practicable. In some embodiments, some or all of the steps of the method 100 may be performed or completed by a merchant, server, customer device and/or another device or party, as will be discussed in more detail below.

There are many embodiments in which the method 100 may be implemented. For example, a merchant may establish an account with a customer to allow the customer to save money for use with later purchases made by the customer at the merchant. The merchant may collect money from the customer after the establishment date for the account until the activation date of the account. During this time, the merchant may add bonus amounts to the account if the customer satisfies one or more requirements. For example, the merchant may add two dollars to the account each time the customer visits the merchant, five dollars each time the customer makes a purchase over fifty dollars at the merchant, a percentage of each purchase made by the customer at the merchant, etc. Alternatively, or in conjunction, the merchant may add a bonus amount to the account that is a percentage of the amount added to the account by the customer. Upon the activation date, the merchant may issue a credit certificate, debit card, gift card, etc. to the customer that entitles the customer to use all monies accumulated in the account to make purchases at the merchant. A gift card may store the current balance available to the customer, which will be reduced each time the customer uses the gift card to make a purchase. Other embodiments and implementations will be provided below.

Processing for the method 100 begins at a step 102 during which an account is established for a customer. The account may be established by a merchant or by a server or other device or entity on behalf of one or more merchants. The account allows the customer to save or store a benefit for later use by the customer. For example, the account may allow the customer to save money by adding or depositing money into the account. The account may have a zero balance when first established or a non-zero balance. If the account is established by a merchant on behalf of a customer, the merchant and/or the customer may provide a non-zero balance upon the establishment of the account. For example, the merchant may associate twenty dollars with the account when the account is established as a motivation to the customer to establish the account. An “account” may be a financial account, log, record, point total, etc. and does not necessarily require a bank account or involvement by another financial savings system or institution. An account also may be a part or portion of a pool of funds collected by a merchant 202 and/or the service provider 208 from customers. Thus, in some embodiments, accounts for multiple customers may be kept or co-mingled together for ease of operation.

In some embodiments, an account may be established for a specific customer by or on behalf of a specific merchant. Thus, the account is associated with the merchant as well as the customer. In some embodiments, an account may have a minimum and/or a maximum balance associated with it.

In some embodiments, any monies or other benefits associated with an account may not be accessed or otherwise used by the customer until a later time. For example, an account may be established in January by a merchant for a customer. Either the merchant or the customer may be able to increase a benefit associated with the account until November but the customer cannot use the any benefit associated with the account until November. Thus, the account allows the benefit to accrue between January and November for later use by the customer. The date at which the customer can access, partake of, or otherwise use a benefit associated with an account will be referred to herein as the “activation date” of the account. The date at which the account is first created will be referred to herein as the “establishment date” of the account. An activation date associated with an account may be days, weeks, months, or years after the establishment date associated with the account.

In some embodiments, the activation date for an account will be established by a merchant and/or customer when the account is established. Thus, the activation date is known to the customer when the customer establishes the account.

In some embodiments, the exact activation date for an account may not be specified when the account is first established. Thus, in some embodiments, the method 100 may include determining the activation date or associating a criterion or requirement with the account that must be satisfied before the account can be activated. For example, the activation date for an account may occur only when the account has an associated benefit level equal to or above a designated threshold. More specifically, an account may have to have a minimum monetary balance associated with it before the account will be activated. In other embodiments, the activation date for an account may depend on an external event. For example, an account may be activated only on a customer's birthday, only when a sale is occurring at a merchant associated with an account, only when the Dow Jones Industrial Average reaches a designated level, only on a Tuesday, only when the customer has first completed some other requirement or criterion (e.g., the customer must visit a merchant a minimum number of times before the account is activated) associated with the account, only during a holiday season, etc.

In some embodiments, an account may have a termination date associated with it. Typically, the termination date will be after the activation date. For example, a merchant may want to allow a customer to save money in an account from January through October. The account may be activated on November first and terminated on December thirty-first. Thus, the customer can save money in an account for ten months and use the saved money for two months before the account is terminated. Unused money in an account may be returned to the customer, forfeited by the customer after an account is terminated, or added to a new account established for the customer for the following year.

A benefit associated with an account may be or include a monetary amount, frequent flyer miles, store credits, redemption points, long distance calling minutes, or some other benefit. In some embodiments, the benefit associated with an account will be a monetary amount that is built up by a customer for later use by the customer at one or more merchants. One or more of the merchants also may add to the monetary amount associated with the account.

In some embodiments, the step 102 or the method 100 may include one or more of the following: associating an account identifier with the customer; providing a notice of the account to the customer; providing a notice of the account to a merchant associated with the account; establishing the account with a zero monetary balance; establishing the account with a non-zero monetary balance; etc.

During a step 104, the customer associated with the account established during the step 102 is allowed to increase a benefit associated with the account. Prior to the step 104, the account may not have a benefit value associated with it (thus the benefit has a zero balance). Alternatively, the benefit associated with the account may be a monetary amount and, prior to the step 104, the benefit may have a zero or a non-zero balance. For purposes of the present invention, a benefit can be associated with an account even if the benefit has a zero initial balance or value (e.g., the balance for the account at the establishment date is zero).

During the step 104 the customer may add to or increase the benefit associated with an account more than one. For example, the step 102 may occur on February tenth when an account for the customer is first established. The account may have a zero balance associated with it when first established and an activation date of October fifteenth of the same year. Between February tenth and October fifteenth, the customer may make multiple increases to the balance of the account, thereby building up the balance of the account. Thus, the step 104 may occur over a period of time.

When the account has a zero initial balance (e.g., the balance of the benefit associated with the account when the account is first established is zero), the customer associates the first real or non-zero value benefit with the account.

As one example of the step 104, the account may be associated with a monetary amount by a merchant on behalf of a customer. The customer can deposit to the account or increase the monetary amount associated with the account by mailing or otherwise sending the merchant cash, a check, money order, etc. for deposit with the account. In this sense, the merchant may act as a kind of bank or financial institution for the customer. The customer increases the benefit associated with the account by adding money to the account after the establishment date. As previously discussed above, however, the customer may not be able to use or access the benefit until the activation date associated with the account.

In some embodiments, the step 104 or the method 100 may include one or more of the following: allowing the customer to associate a monetary amount with the account; allowing the customer to provide money and associating the money with the account; allowing the customer to make a money deposit, the deposit being associated with the account; allowing the customer to increase a zero monetary balance initially associated with the account; allowing the customer to add to a non-zero monetary balance initially associated with the account; etc.

During a step 106, a benefit is associated with the account on the activation date by the merchant or other party or device implementing the method 100. For example, a merchant may add fifty dollars, fifty points, or fifty purchase credits to an account upon the activation date. In some embodiments, the amount added to an account by a merchant at the activation date during the step 106 may depend, at least in part, on the amounts added by the customer prior to the activation date. For example, a merchant may add an amount to an account on the activation date for the account that is equal to ten percent of the money added by the customer after the account's establishment date and prior to the account's activation date. Thus, the merchant is rewarding the customer based on how much money the customer has added to the account. The merchant may inform the customer of the availability of the bonus amount when the account is established (thereby maximizing the incentive of the customer to increase the balance of the account) or only when the bonus is added at the activation date (thereby increasing the flexibility of the merchant regarding what bonus to provide to the customer or to associate with the account). In this system, the customer is allowed to save money for later use and receive a bonus for such saving, even though the customer cannot easily access the money until the activation date associated with the account. The customer may still be able to add money to the account after the activation date.

As one example, a merchant may add bonus monetary amount to an account as follows: For $100.00 to $199.00 added by a customer, the merchant may add $10.00. For $200.00 to $299.00 added by a customer, the merchant may add $20.00. For $300.00 to $399.00 added by a customer, the merchant may add $30.00. For $400.00 to $499.00 added by a customer, the merchant may add $40.00. For $400.00 or more added by a customer, the merchant may add $50.00. Thus, the customer may receive a maximum bonus with the account. In some embodiments, a bonus may have a minimum and/or maximum value or amount.

In some embodiments, the benefit added during the step 106 will be of the same type as added by the customer during the step 104. For example, both may be monetary amounts, shopping credits, etc. In other embodiments, the benefit added during the step 106 will be of a different type than the benefits added by the customer during the step 106. For example, the customer may add monetary amounts during the step 104 while a merchant may add actual products as benefits during the step 106.

In some embodiments, the step 106 or the method 100 may include determining the benefit added during the step 106. The amount of the benefit may be based, in whole or in part, on a formula, algorithm, rule, procedure, heuristic, etc. In some embodiments, there may be a minimum and/or maximum benefit that can be added to an account.

In some embodiments, the step 106 or the method 100 may include increasing a monetary amount associated with the account; increasing a monetary amount associated with the account in proportion to increases to the monetary amount added by the customer; and increasing a monetary amount associated with the account by a predetermined percentage of increases to the monetary amount added by the customer.

During a step 108, the customer associated with the account established during the step 102 is allowed to access the benefits associated with the account. For example, the customer is allowed to use all of the benefits built up by the customer since the account was established and all the benefits added to the account at the activation date during the step 106.

In some embodiments, the step 108 or the method 100 may include allowing the customer to receive the first benefit after the activation date; allowing the customer to receive the second benefit after the activation date; allowing the customer to receive any monetary amounts associated with the account after the activation date; allowing the customer to use any monetary amounts associated with the account after the activation date; etc.

In some embodiments, the method 100 may include identifying the customer prior to establishing the account. For example, the method 100 may include selecting which customers to offer accounts to, confirming an identity of a customer prior to establishing an account for the customer, etc.

In some embodiments, the method 100 may include providing a notification to a customer informing the customer of the availability of an account, availability of a bonus amount for an account, an activation date associated with an account, a current or expected balance associated with an account, an accumulated benefit associated with an account, a termination date associated with an account, the status of a benefit that may be added to an account, etc. A notification may be provided to a customer in or as part of an email message; instant message communication; wireless transmission; HTML, FTP or XML transmission; radio signal; letter; facsimile transmission; or some other electronic signal or communication.

In some embodiments, a merchant may add money to the account merely by increasing the bonus associated with the account. For example, the merchant could decide to add ten dollars to the account. The merchant may allow the customer to receive an additional ten dollars in store credit when the customer visits the merchant, even though the merchant is not actually giving the customer the ten dollars.

In some embodiments, the merchant may allow the customer to complete a task or activity and then reward the customer by adding money to the account. For example, a merchant may want to increase the number of shoppers visiting the merchant. The merchant may inform one or more customers via an email message, instant message communication, telephone call, facsimile transmission, etc. that the customers can get an extra ten dollars in bonus if they visit the merchant on one or more designated days or hours (e.g., Mother's Day, first Tuesday of the month, evening hours when the merchant tends to be less busy).

In some embodiments, a customer may be able to withdraw or decrease a benefit associated with an account prior to the activation date. Such early use or decrease may have a penalty associated with it or require that the customer satisfy some other criterion or requirement. Thus, in some embodiments, the method 100 may include determining a penalty, assessing a penalty, informing the customer of the penalty or possibility of a penalty, etc.

As another example of how the method 100 might be implemented. A service provider may implement the method on behalf of one or more of merchants. The service provider may charge the merchant(s) or receive compensation from the merchant for providing the service. For example, the service provider may receive interest from the money provided by customers to an account, receive a transaction fee from the merchant for each use of the account by the customer, receive a flat management fee from the merchant, etc. The service provider may use some of the money received from the merchant or generated from the interest to advertise to potential customers and/or provide bonus amounts.

At the request of a customer and/or a merchant, the service provider may establish an account for the customer. The service provider, merchant, and/or customer may designate the activation date associated with the account. The account may have a zero initial benefit associated with it or a non-zero initial benefit associated with it. For example, the merchant may add ten dollars to the account as soon as the account is established to provide an initial benefit to the customer, even though the customer cannot access the benefit until the activation date. Over time, the merchant may want to add bonus amounts to the account. For example, the merchant may add five dollars to the account on the customer's birthday, five dollars to the account if the customer makes a purchase at the merchant on a designated day, etc. The merchant may provide a notification to the service provider that the merchant has increased the bonus amount.

The merchant may provide monetary funds to the service provider to cover the bonuses added by the merchant as soon as the merchant adds them, when the merchant is billed by the service provider, or at some other time. Either the service provider or the merchant may receive money from the customer to add to the account. The merchant may provide the money to the service provider or merely indicate to the service provider that the merchant has received the money from the customer. After the establishment date, and prior to and on the activation date, the service provider may send statements or other notices to the merchant and/or the customer regarding the account, the balance in the account, bonuses added to the account, funds received from the customer for the account, etc. Upon the activation date, the service provider may provide a gift certificate, debit card, or a loaded gift card to the customer that the customer can use at the merchant. In addition, the service provider may add any remaining bonus amounts to the account. The service provider may inform the merchant of the account total. Additionally, the merchant may transfer some or all monies in the account to the merchant. In this case, the service provider acts as a sort of bank for the merchant to collect and hold the customer's money. Alternatively, the service provider may provide payment to the merchant only when billed by the merchant, which will occur after a customer makes a purchase at the merchant using the account. In this case, the service provider acts a sort of credit settlement agent in that the service provider receives money from the customer and then remits money to the merchant when the customer makes purchases at the merchant.

In some embodiments, the bonus added to an account may vary depending on customer action. For example, a customer that visits a merchant may receive a ten percent for each dollar added to the account by the customer while at the merchant. In contrast, the customer may only receive a five percent bonus from the merchant if the customer mails the money to the merchant or the service provider. Thus, the merchant is motivating the customer both to visit the merchant prior to the activation date and to save money for use at the merchant after the activation date.

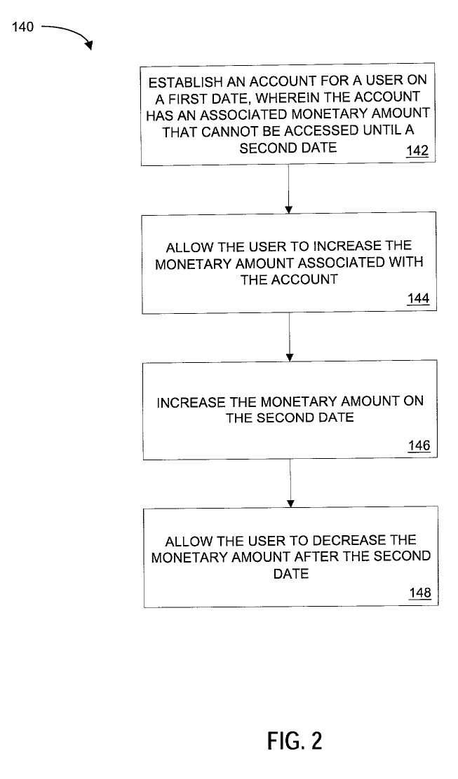

Reference is now made to FIG. 2, where a flow chart 140 is shown which represents the operation of a second embodiment of the present invention. The particular arrangement of elements in the flow chart 140 is not meant to imply a fixed order to the steps; embodiments of the present invention can be practiced in any order that is practicable. In some embodiments, some or all of the steps of the method 140 may be performed or completed by a merchant, server, customer device and/or another device, as will be discussed in more detail below. In some embodiments, the method 140 may include some or all of the variations discussed above in regard to the method 100.

Processing begins at a step 142 during which an account is established for a customer on a first date (i.e., the establishment date). The account has an associated monetary amount, but the account may not, in some embodiments,e used until a second date (i.e., the activation date). The monetary amount first associated with the account may be a zero amount, a default amount, etc. and does not need to be specially identified when the account is established. The step 142 is similar to the step 102 previously discussed above. The account may be associated with a specific customer and/or a specific merchant. In addition, the account may have a specific activation date and/or a specific termination date associated with it.

During a step 144, the customer associated with the account is allowed to increase the monetary amount associated with the account. The step 144 is similar to the step 104 previously discussed above. In some embodiments, an account may have a minimum and/or a maximum monetary amount balance associated with it.

During a step 146, a merchant or other party or device implementing the step 140 increases the monetary amount associated with the account on the second date (i.e., on the activation date). The step 146 is similar to the step 106 previously discussed above.

In some embodiments, the amount of the increase provided during the step 146 may depend on how much the customer has added to or increased the monetary amount of the account. In other embodiments, the amount of the increase provided during the step 146 may be a fixed amount or determined by some other party or event. Thus, the step 146 or the method 140 may include receiving a communication regarding how much to increase the monetary amount of the account. In some embodiments, there may be a minimum and/or maximum benefit that can be added to an account.

During a step 148, the customer is allowed to decrease the monetary amount after the second date (i.e., after the activation date). In some embodiments, the customer may decrease the monetary amount associated with the account by spending the money from the account, withdrawing the money from the account, assigning the money to another account, providing the money to another customer for use, donating the money, etc.

In some embodiments, the method 140 may include providing a notification to a customer informing the customer of the availability of an account, availability of a bonus amount for an account, an activation date associated with an account, a balance associated with an account, an accumulated benefit associated with an account, a termination date associated with an account, etc. A notification may be provided to a customer in or as part of an email message; instant message communication; wireless transmission; HTML, FTP or XML transmission; radio signal; letter; facsimile transmission; or some other electronic signal or communication. In some embodiments, the method 140 may include determining an activation date and/or a termination date associated with an account, determining a bonus monetary amount to add to an account during the step 146, receiving a monetary amount from a customer to add to an account, offering an account to a customer, determining and/or assessing a penalty for early withdraw by a customer from an account, etc. etc.

In some embodiments, the method 140 may include one or more of the following: associating an account identifier with the customer; providing a notice of the account to the customer; providing a notice of the account to a merchant associated with the account; establishing the account with a zero monetary balance; establishing the account with a non-zero monetary balance; determining a merchant associated with an account; providing a notification to the customer of a merchant associated with the account; determining a merchant associated with the account; etc.

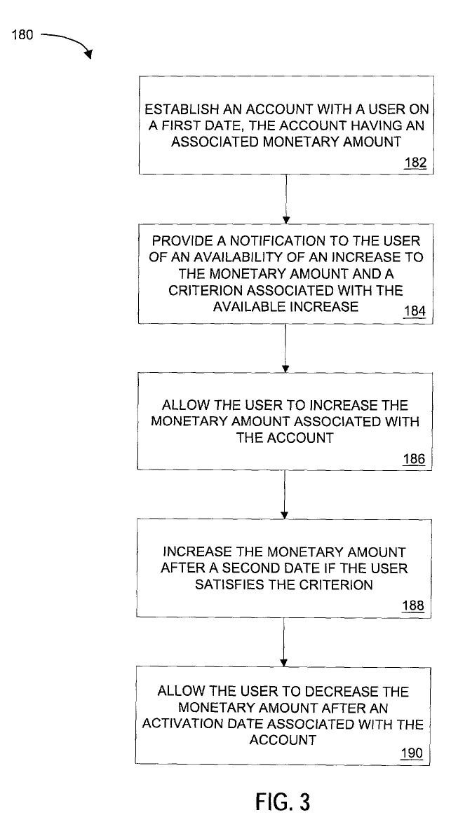

Reference is now made to FIG. 3, where a flow chart 180 is shown which represents the operation of a third embodiment of the present invention. The particular arrangement of elements in the flow chart 180 is not meant to imply a fixed order to the steps; embodiments of the present invention can be practiced in any order that is practicable. In some embodiments, some or all of the steps of the method 180 may be performed or completed by a merchant, server, customer device and/or another device or party, as will be discussed in more detail below. In some embodiments, the method 180 may include some or all of the variations discussed above in regard to the method 100 and/or the method 180.

Processing begins at a step 182 during which an account is established for a customer on a first date, wherein the account has an associated monetary amount. The associated monetary amount may be a zero or non-zero amount. The account may be associated with or for a specific merchant or group of merchants. The step 182 is similar to the step 102 and 142 previously discussed above.

During a step 184, a notification is provided to the customer regarding an availability of an increase to the monetary amount associated with the account. The notification also may include a criterion associated with the increase. For example, a merchant may increase a monetary amount associated with an account by ten percent of the amount provided by the customer to the account. Thus, the criterion to obtain this bonus monetary amount is that the customer must add money to the account. As another example, the merchant may only add the ten percent for each one hundred dollar amount added by the customer. Thus, the criterion requires that the customer add at least one hundred dollars to the account before the merchant will add any bonus monetary amount to the account.

The notification may be provided to a customer in or as part of an email message; instant message communication; wireless transmission; HTML, FTP or XML transmission; radio signal; letter; facsimile transmission; or some other electronic signal or communication.

During a step 186, the customer is allowed to increase the monetary amount associated with the account established during the step 182. The step 186 is similar to the steps 104 and 144 previously discussed above.

During a step 188, the monetary amount associated with the account is increased on a second date if the customer meets or otherwise satisfies the criterion indicated during the step 184. In some embodiments, the second date may be an activation date.

In some embodiments, the step 188 or the method 188 may include determining if the criterion has been met or satisfied, receiving an indication from the customer or another party or device that the criterion has or has not been met or satisfied, confirming whether or not the criterion has been met or satisfied, requesting from the customer a confirmation of whether or not the criterion has been met or satisfied, determining how much to increase the monetary amount associated with the account, etc.

In some embodiments, the amount of the increase provided during the step 188 may depend on how much the customer has added to or increased the monetary amount of the account. In other embodiments, the amount of the increase provided during the step 188 may be a fixed amount or determined by some other party or event. Thus, the step 188 or the method 180 may include receiving a communication regarding how much to increase the monetary amount of the account.

During a step 190, a customer is allowed to decrease the monetary amount after an activation date. In some embodiments, the activation date used in the step 190 may be the same date as the second date used in the step 188. The step 190 is similar to the step 148 previously discussed above.

In some embodiments, the method 180 may include providing a notification to a customer informing the customer of the availability of an account, availability of a bonus amount for an account, an activation date associated with an account, a balance associated with an account, an accumulated benefit associated with an account, a termination date associated with an account, etc. A notification may be provided to a customer in or as part of an email message; instant message communication; wireless transmission; HTML, FTP or XML transmission; radio signal; letter; facsimile transmission; or some other electronic signal or communication. In some embodiments, the method 180 may include determining an activation date and/or a termination date associated with an account, determining a bonus monetary amount to add to an account during the step 188, receiving a monetary amount from a customer to add to an account, determining and/or assessing a penalty for early withdraw by a customer from an account, etc.

In some embodiments, the method 180 may include one or more of the following: associating an account identifier with the customer; providing a notice of the account to the customer; providing a notice of the account to a merchant associated with the account; establishing the account with a zero monetary balance; providing a notice to the customer of a merchant associated with the account; establishing the account with a non-zero monetary balance; determining a merchant associated with an account; etc.

System

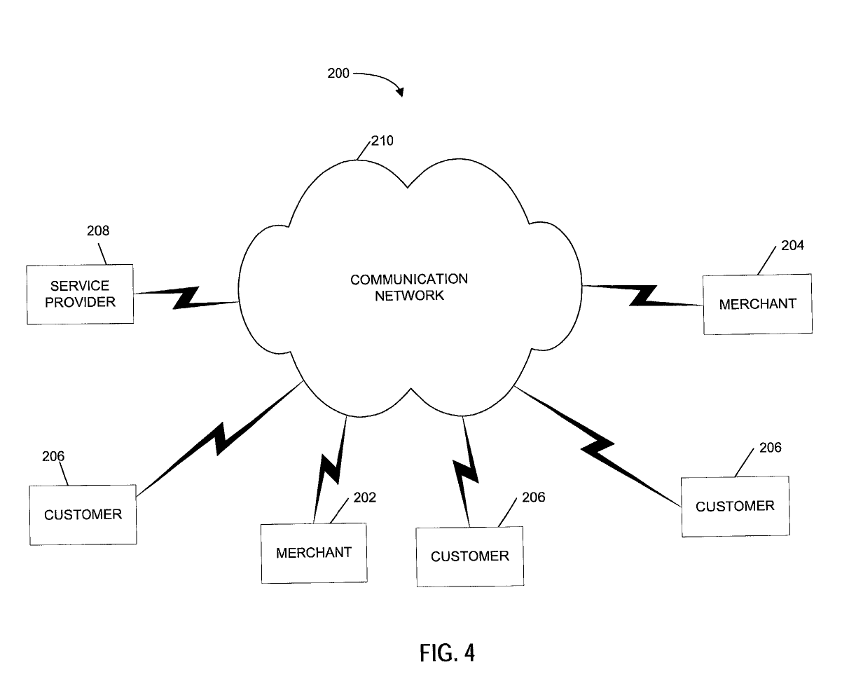

Now referring to FIG. 4, an apparatus or system 200 usable with the methods disclosed herein is illustrated. The apparatus 200 includes one or more merchants 202, 204 that may communicate directly or indirectly with one or more customers 206, service providers 208 and/or other parties or devices via a computer, data, cable, telephone, or other communications network 210. For purposes of further explanation and elaboration of the methods disclosed herein, the methods disclosed herein will be assumed to be operating on, or under the control of, one the merchants 202 or 204. In some embodiments, however, one or more of the methods disclosed herein may be implemented or conducted by a party or device (e.g., a service provider 208) on behalf of one or more merchants.

A merchant may be any type or wholesaler, retailer, supplier, manufacturer, restaurant, etc. A supplier may be any entity that provides goods and services to merchants and/or customers.

A merchant 202 may implement or host a Web site. A merchant 202 can comprise a single device or computer, a networked set or group of devices or computers, a workstation, etc. In some embodiments, a merchant 202 also may function as a database server, Web site server, etc. The use, configuration and operation of a device for the merchant 202 will be discussed in more detail below.

Customers 206 may use customer or client devices to interact with the merchant 202 and the remainder of the apparatus 200. The customer devices also may enable customers to access Web sites, software, databases, etc. hosted or operated by the merchant 202. If desired, customer devices also may be connected to or otherwise in communication with other devices. Possible customer devices include a personal computer, portable computer, mobile or fixed customer station, workstation, network terminal or server, cellular telephone, kiosk, dumb terminal, personal digital assistant, etc. In some embodiments, information regarding one or more customers and/or one or more customer devices may be stored in, or accessed from, a customer information database and/or a customer device information database.

Many different types of implementations or hardware configurations can be used in the system 200 and with the methods disclosed herein and the methods disclosed herein are not limited to any specific hardware configuration for the system 200 or any of its components.

The communications network 210 might be or include the Internet, the World Wide Web, or some other public or private computer, cable, telephone, client/server, peer-to-peer, or communications network or intranet, as will be described in further detail below. The communications network 210 illustrated in FIG. 4 is meant only to be generally representative of cable, computer, telephone, peer-to-peer or other communication networks for purposes of elaboration and explanation of the present invention and other devices, networks, etc. may be connected to the communications network 210 without departing from the scope of the present invention. The communications network 210 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a customer may be connected to or in communication with a merchant 202 without departing from the scope of the present invention. Moreover, as used herein, communications include those enabled by wired or wireless technology.

Although two merchants 202, 204, three customers 206 and one service provider 208 are shown in FIG. 4, any number of such parties or devices may be included in the system 200. The parties shown in FIG. 4 need not be in constant communication. For example, a customer 206 may communicate with the merchant 202 only when such communication is appropriate or necessary.

Server

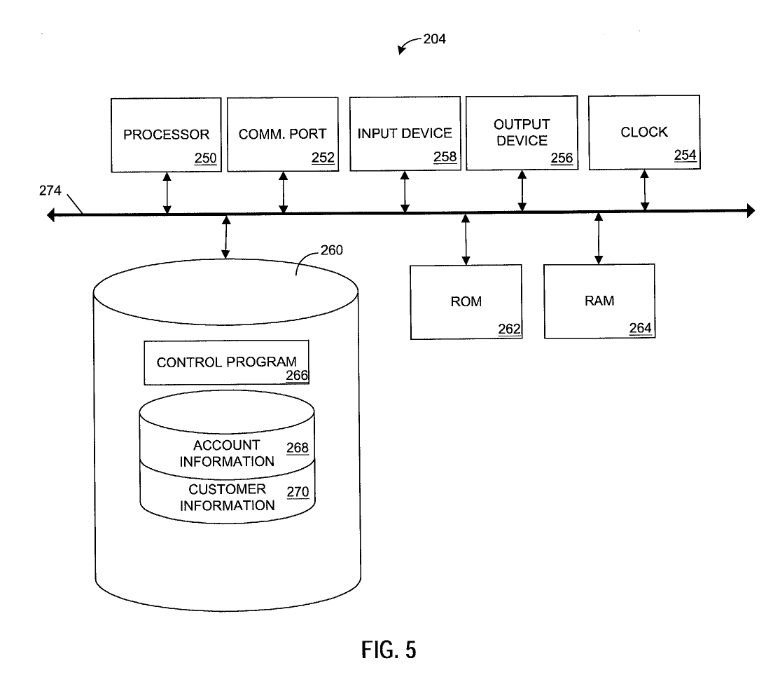

Now referring to FIG. 5, a representative block diagram of a server or controller 240 is illustrated that may be used by or for the merchant 202. The server 240 may include a processor, microchip, central processing unit, or computer 250 that is in communication with or otherwise uses or includes one or more communication ports 252 for communicating with customer devices and/or other devices. Communication ports may include such things as local area network adapters, wireless communication devices, Bluetooth technology, etc. The server 240 also may include an internal clock element 254 to maintain an accurate time and date for the server 240, create time stamps for communications received or sent by the server 240, etc. A service provider 208 that implements one or more of the methods disclosed herein on behalf of one or more merchants may include some or all of the components, software, etc. illustrated in FIG. 5.

If desired, the server 240 may include one or more output devices 256 such as a printer, infrared or other transmitter, antenna, audio speaker, display screen or monitor, text to speech converter, etc., as well as one or more input devices 258 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 240 may include a memory or data storage device 260 to store information, software, databases, communications, device drivers, advertisements, etc. The memory or data storage device 260 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The server 240 also may include separate ROM 262 and RAM 264.

The processor 250 and the data storage device 260 in the server 240 each may be, for example: (i) located entirely within a single computer or other computing device; or (ii) connected to each other by a remote communication medium, such as a serial port cable, telephone line or radio frequency transceiver. In one embodiment, the server 240 may comprise one or more computers that are connected to a remote server computer for maintaining databases.

A conventional personal computer or workstation with sufficient memory and processing capability may be used as the server 240. In one embodiment, the server 240 operates as or includes a Web server for an Internet environment. The server 240 preferably is capable of high volume transaction processing, performing a significant number of mathematical calculations in processing communications and database searches. A Pentium™ microprocessor such as the Pentium IV™ microprocessor, manufactured by Intel Corporation may be used for the processor 250. Equivalent processors are available from Motorola, Inc., AMD, or Sun Microsystems, Inc. The processor 250 also may comprise one or more microprocessors, computers, computer systems, etc.

Software may be resident and operating or operational on the server 240. The software may be stored on the data storage device 260 and may include a control program 266 for operating the server, databases, etc. The control program 266 may control the processor 250. The processor 250 preferably performs instructions of the control program 266, and thereby operates in accordance with the present invention, and particularly in accordance with the methods described in detail herein. The control program 266 may be stored in a compressed, uncompiled and/or encrypted format. The control program 266 furthermore includes program elements that may be necessary, such as an operating system, a database management system and device drivers for allowing the processor 250 to interface with peripheral devices, databases, etc. Appropriate program elements are known to those skilled in the art, and need not be described in detail herein.

The server 240 also may include or store information regarding customers, bonuses, transactions, accounts, products, marketing efforts, sales and other promotions, inventories, merchants, employees, revenues, suppliers, financial accounts, notifications or other communications, etc. For example, information regarding one or more accounts may be stored in an account information database 268 for use by the server 240 or another device or entity. Information regarding one or more customers may be stored in a customer information database 270 for use by the merchant 202 or another device or entity.

According to an embodiment of the present invention, the instructions of the control program may be read into a main memory from another computer-readable medium, such as from the ROM 262 to the RAM 264. Execution of sequences of the instructions in the control program causes the processor 250 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 250, communication port 252, clock 254, output device 256, input device 258, data storage device 260, ROM 262, and RAM 264 may communicate or be connected directly or indirectly in a variety of ways. For example, the processor 250, communication port 252, clock 254, output device 256, input device 258, data storage device 260, ROM 262, and RAM 264 may be connected via a bus 274.

While specific implementations and hardware configurations for servers 204 have been illustrated, it should be noted that other implementations and hardware configurations are possible and that no specific implementation or hardware configuration is needed. Thus, not all of the components illustrated in FIG. 5 may be needed for a server implementing the methods disclosed herein. Therefore, many different types of implementations or hardware configurations can be used in the system 200 and the methods disclosed herein are not limited to any specific hardware configuration.

Customer Device

As mentioned above, a customer device may be or include any of a number of different types of devices, including, but not limited to a personal computer, portable computer, mobile or fixed customer station, workstation, network terminal or server, telephone, beeper, kiosk, dumb terminal, personal digital assistant, facsimile machine, two-way pager, radio, cable set-top box, etc. In some embodiments, a customer device may have the same structure or configuration as the server 240 illustrated in FIG. 5 and include some or all of the components of the server 240.

Databases

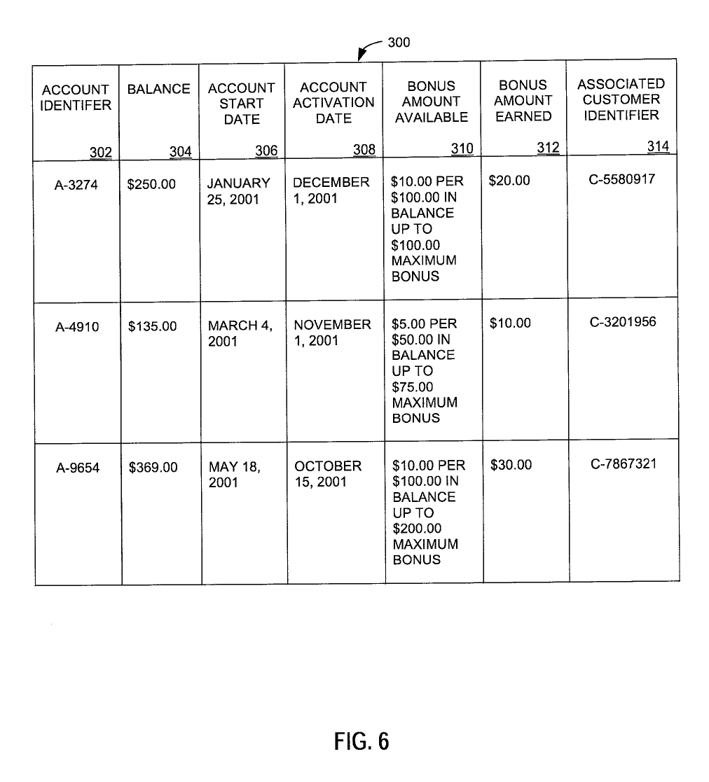

As previously discussed above, in some embodiments a merchant, customer, server, customer device, or other party or device may include or access an account information database for storing or keeping information regarding one or more accounts. One representative account information database 300 is illustrated in FIG. 6.

The account database 300 may include an account identifier field 302 that may include codes or other identifiers for one or more accounts, an account balance field 304 that may include information regarding balances for the accounts identified in the field 302, an account start date field 306 that may include information regarding when the accounts identified in the field 302 were started or established, and account activation field 308 that may include information regarding when the accounts identified in the field 302 are activated or may be used, a bonus available field 310 that may include information regarding bonus amounts available for the accounts identified in the field 302, a bonus a bonus earned field 312 that may include information regarding bonus amounts earned by the accounts identified in the field 302, and an associated customer identifier field 302 that may include codes or other identifiers for one or more customers associated with the accounts identified in the field 302.

Other or different fields also may be used in the account information database 300. For example, in some embodiments an account information database may include transaction history related to the account, information regarding the date of termination of the account, information regarding bonus amounts or types awarded, etc.

As illustrated by the account information database 300 of FIG. 6, the account identified as “A-3274” in the field 302 is associated with the customer identified as “C-5580917” and has a current balance of “$250.00”. The account “A-3274” was established on Jan. 25, 2001, and will be activated on Dec. 1, 2001. The account allows for bonus amounts to be awarded in ten dollars increments for each one hundred dollar amount added to the account by the customer up to a maximum bonus of one hundred dollars. So far, the account “A-3274” has earned a bonus of twenty dollars.

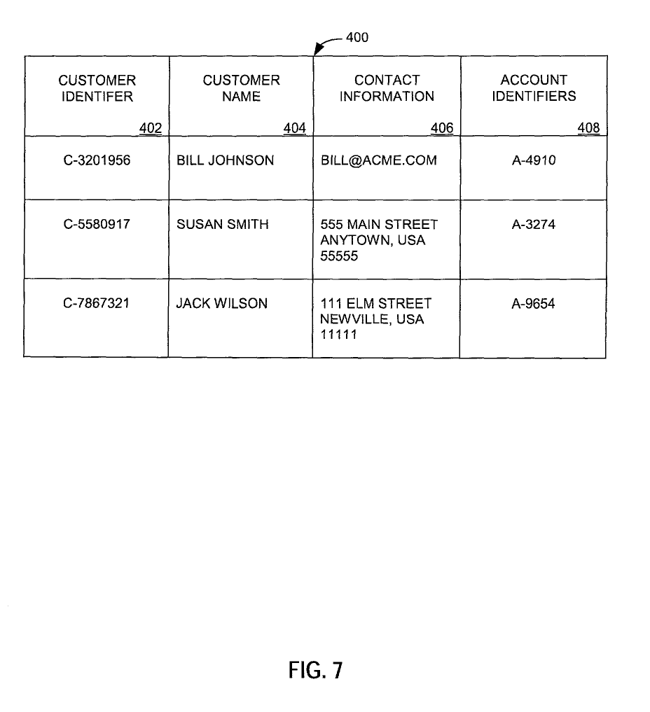

As previously discussed above, in some embodiments a merchant, customer, server, customer device, or other party or device may include or access a customer information database for storing or keeping information regarding one or more customers. One representative customer information database 400 is illustrated in FIG. 7.

The customer information database 400 may include a customer identifier field 402 that may include codes or other identifiers for one or more customers, customer name field 404 that may include names or other descriptive information for the customers identified in the field 402, a contact information field 406 that may include email addresses, postal addresses, telephone numbers, facsimile numbers, or other contact information for the customers identified in the field 402, and an account identifier field 408 that may include codes or other identifiers for accounts associated with the customers identified in the field 402.

Other or different fields also may be used in the customer information database 400. For example, in some embodiments a customer information database may include demographic information (e.g., gender, age, occupation, marital status), preference information (e.g., color, size, manufacturer, hobbies or interests), credit history or credit report information, purchasing and other transaction history information, financial account information (e.g., credit card numbers, bank account numbers), etc. for the customers identified in the field 402.

As illustrated by the customer information database 400 of FIG. 7, the customer identified as “C-3201956” in the field 402 is named “BILL JOHNSON” and can be contacted via the email address “BILL@ACME.COM”. The customer “C-3201956” is associated with the account identified as “A-4910”.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for providing a benefit to a customer, comprising:
establishing an account for a customer;
allowing said customer to increase a first benefit associated with said account, wherein said customer cannot use said first benefit until an activation date associated with said account;
associating a second benefit with said account at said activation date; and
allowing said customer to use said first benefit and said second benefit after said activation date.

2. The method of claim 1, wherein said establishing an account for a customer includes at least one of the following:
associating an account identifier with said customer;
providing a notice of said account to said customer;
providing a notice of said account to a merchant associated with said account;
establishing said account with a zero monetary balance; and
establishing said account with a non-zero monetary balance.

3. The method of claim 1, wherein said allowing said customer to increase a first benefit associated with said account, wherein said customer cannot use said first benefit until an activation date associated with said account includes at least one of the following:
allowing said customer to associate a monetary amount with said account;
allowing said customer to provide money and associating said money with said account;
allowing said customer to make a money deposit, said deposit being associated with said account;
allowing said customer to increase a zero monetary balance initially associated with said account; and
allowing said customer to add to a non-zero monetary balance initially associated with said account.

4. The method of claim 1, wherein said associating a second benefit with said account at said activation date includes at least one of the following:
increasing a monetary amount associated with said account;
increasing a monetary amount associated with said account in proportion to increases to said monetary amount added by said customer; and
increasing a monetary amount associated with said account by a predetermined percentage of increases to said monetary amount added by said customer.

5. The method of claim 1, wherein said allowing said customer to use said first benefit and said second benefit after said activation date includes at least one of the following:
allowing said customer to receive said first benefit after said activation date;
allowing said customer to receive said second benefit after said activation date;
allowing said customer to receive any monetary amounts associated with said account after said activation date; and
allowing said customer to use any monetary amounts associated with said account after said activation date.

6. The method of claim 1, further comprising:
determining said activation date.

7. The method of claim 1, wherein said first benefit is a monetary amount.

8. The method of claim 1, further comprising:
identifying said customer.

9. The method of claim 1, further comprising:
providing a notification to said customer indicative of an availability of said account.

10. The method of claim 1, further comprising:
providing a notification to said customer indicative of availability of said second benefit.

11. The method of claim 1, further comprising:
providing a notification to said customer indicative of said activation date.

12. The method of claim 1, further comprising:
determining said second benefit.

13. The method of claim 1, wherein said second benefit is a monetary amount.

14. The method of claim 1, further comprising:
providing at least one notification to said customer of an accumulated benefit associated with said account prior to said activation date and after said account is established.

15. The method of claim 1, wherein said first benefit is associated with said account by said customer.

16. The method of claim 1, wherein said account has a zero initial benefit.

17. The method of claim 1, wherein said account has a zero initial benefit until such time as said customer associates said first benefit with said account.

18. The method of claim 1, further comprising:
associating said account with a merchant.

19. The method of claim 18, further comprising:
allowing said merchant to provide said second benefit.

20. The method of claim 18, further comprising:
allowing said merchant to associate a third benefit with said account.

21. The method of claim 1, wherein said account has an associated termination date.

22. The method of claim 1, wherein said second benefit is based on an increased amount of said first benefit provided by said customer.

23. The method of claim 1, further comprising:
providing a notice of said account to a merchant associated with said account;

24. The method of claim 1, further comprising:
identifying a merchant associated with said account.

25. A method for providing a benefit to a customer, comprising:
establishing an account for a customer on a first date, wherein said account has an associated monetary amount and said customer cannot decrease said monetary amount until a second date;
allowing said customer to increase said monetary amount after said first date;
increasing said monetary amount at said second date; and
allowing said customer to decrease said monetary amount associated with said account after said second date.

26. The method of claim 25, further comprising:
determining a merchant associated with said account.

27. The method of claim 26, further comprising:
providing a notification of said account to said merchant.

28. The method of claim 26, further comprising:
providing a notification of said merchant to said customer.

29. The method of claim 25, wherein said allowing said customer to decrease said monetary amount associated with said account after said second date includes at least one of the following:
allowing said customer to receive said monetary amount after said second date; and
allowing said customer to use said monetary amount after said second date.

30. The method of claim 25, wherein said monetary amount is zero when account is established.

31. The method of claim 25, further comprising:
determining said second date.

32. The method of claim 25, further comprising:
providing a notification to said customer of said second date.

33. The method of claim 25, further comprising:
providing a notification to said customer of an availability of an increase to said monetary amount.

34. The method of claim 25, further comprising:
providing a notification to said customer of an availability of an increase to said monetary amount and at least one criterion that must be met for said customer to obtain said increase.

35. The method of claim 25, further comprising:
offering said account to said customer.

36. The method of claim 25, further comprising:
selecting said customer.

37. The method of claim 25, further comprising:
providing at least one notification to said customer indicative of a monetary amount associated with said account.

38. The method of claim 25, further comprising:
associating said account with a merchant.

39. The method of claim 38, further comprising:
allowing said merchant to increase said monetary amount.

40. The method of claim 38, further comprising:
allowing said merchant to associate a benefit with said account.

41. The method of claim 25, further comprising:
determining how much to increase said monetary amount at said second date

42. The method of claim 25, wherein said account has a zero monetary amount associated with it until such time as said customer increases said monetary amount.

43. A method for providing a benefit to a customer, comprising:
establishing an account for a customer on a first date, wherein said account has an associated monetary amount and said customer cannot decrease said monetary amount until an activation date;
providing a notification to said customer indicative of availability of an increase to said monetary amount benefit at said second date an a criterion associated with said increase to said monetary amount;
allowing said customer to increase said monetary amount after said first date and before said second date;
increasing said monetary amount at said second date if said customer satisfies said criterion; and
allowing said customer to decrease said monetary amount after said activation date.

44. The method of claim 43, further comprising:
determining if said customer has satisfied said criterion.

45. The method of claim 43, further comprising:
determining said criterion.

46. The method of claim 43, further comprising:
determining an amount to increase said monetary amount at said second date.

47. The method of claim 43, wherein said account has zero monetary amount associated with it until such time as said customer increases said monetary amount.

48. The method of claim 43, wherein said activation date is said second date.

49. The method of claim 43, wherein said activation date is later than said second date.

50. A system for providing a benefit to a customer, comprising:
a memory;
a communication port; and
a processor connected to said memory and said communication port, said processor being operative to
establish an account for a customer;
allow said customer to increase a first benefit associated with said account, wherein said customer cannot use said first benefit until an activation date associated with said account;
associate a second benefit with said account at said activation date; and
allow said customer to use said first benefit and said second benefit after said activation date.

51. A computer program product in a computer readable medium for providing a benefit to a customer, comprising:
first instructions for associating an account with a customer;
second instructions for increasing a first benefit associated with said account, wherein said customer cannot use said first benefit until an activation date associated with said account;
third instructions for adding a second benefit to said account at said activation date; and
fourth instructions for granting use by said customer to said first benefit and said second benefit after said activation date.
